(19) United States
(12) Patent Application Publication
(10) Pub. No.: US 2007/0098123 A1
(43) Pub. Date: May 3, 2007

(54) Method for controlling the transfer of signals representative of au group of data

(75) Inventor: Yoshitaka Hara, Rennes Cedex 7 (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 11/540,627

(22) Filed: Oct. 2, 2006

(30) Foreign Application Priority Data
Oct. 31, 2005 (EP) 05 023792.4

(51) Int. Cl. H04L 1/02

(52) U.S. Cl. 375/347

(57) ABSTRACT

The present invention concerns a method for controlling the transfer of signals representatives of a group of data in a wireless telecommunication network comprising a first telecommunication device linked through plural second telecommunication devices through-the wireless network, the first telecommunication device comprising at least two antennas, at least one of the second telecommunication devices comprising at least two antennas. The first telecommunication device calculates at least two information, each information being representative of the achievable link conditions between the first telecommunication device and one second telecommunication device, determines which second telecommunication device is involved in the transfer of the group of data through the link according to the determined information and determines at least a weighting vector to be used for the transfer of the group of data, the elements of the weighting vector weighting the signals representatives of the group of data transferred through at least two antennas.

The present invention relates generally to communication systems and in particular, to a method and apparatus for controlling the transfer of signals representatives of a group of data in a wireless telecommunication network.

Telecommunication systems in which, a plurality of antennas are used at a receiver end and/or at a transmitter end of a wireless link, are called Multiple Input Multiple Output systems (further referred to as MIMO systems). MIMO systems have been shown to offer large transmission capacities compared to those offered by single antenna systems. In particular, MIMO capacity increases linearly with the number of transmitting or receiving antennas, whichever the smallest, for a given Signal-to-Noise Ratio and under favourable uncorrelated channel conditions.

Beamforming has been investigated for MIMO systems in order to optimize the range and performance of the wireless link between the receiver end and the transmitter end. Multiple-input multiple-output (MIMO) scheme with beamforming uses antenna signal processing at both ends of the wireless link to maximize the signal-to-noise power ratio (SNR) and/or signal-to-noise-plus-interference power ratio (SNIR), thereby improving the link margin between two telecommunication devices.

Spatial multiplexing methods have been proposed in MIMO systems. In a spatial multiplexing system, at least two independent data streams are transmitted using at least two transmitting antennas respectively. In a receiving end, at least two antennas are used and each antenna receives at least two signals simultaneously. Therefore, the received signals must be recovered separately with a detection algorithm for each signal. The separated signals are decoded independently.

In case of a telecommunication system wherein plural terminals are linked to a base station, it is difficult sometime for the terminals to determine the best weighting vector which weights the signals received or transferred through its antennas as far as it is not aware about the other terminals which are linked to the base station and which may disturb its communication with the base station.

Furthermore, when a single terminal is linked to a base station, or in a point to point communication, the terminal is not aware if there are some other base stations and terminals linked to them in the vicinity of the terminal. Such unawareness of the communication condition on the wireless link limits the ability of a terminal to determine the best weighting vector it has to apply to signals transferred or received through its antennas.

The aim of the invention is therefore to propose a method, and a device which allow telecommunication devices to use the best weighting vectors in order to perform efficient beamforming and to propose a method, and a device which allow in a simple and efficient way the allocation of the radio resources of the wireless network.

To that end, the present invention concerns a method for controlling the transfer of signals representatives of a group of data in a wireless telecommunication network comprising a first telecommunication device linked through plural second telecommunication devices through the wireless network, the first telecommunication device comprising at least two antennas, at least one of the second telecommunication devices comprising at least two antennas, characterised in that the method comprises the steps executed by the first telecommunication device of:

calculating at least two information, each information being representative of the achievable link conditions between the first telecommunication device and one second telecommunication device,

determining which second telecommunication device, among the at least two second telecommunication devices, is involved in the transfer of the group of data through the link according to the determined information,

determining at least a weighting vector to be used for the transfer of the group of data, the elements of the weighting vector weighting the signals representatives of the group of data transferred through at least two antennas.

The present invention concerns also a device for controlling the transfer of signals representatives of a group of data in a wireless telecommunication network comprising a first telecommunication device linked through plural second telecommunication devices through the wireless network, the first telecommunication device comprising at least two antennas, at least one of the second telecommunication devices comprising at least two antennas, characterised in that the device is include in the first telecommunication device and comprises:

means for calculating at least two information, each information being representative of the achievable link conditions between the first telecommunication device and one second telecommunication device,

means for determining which second telecommunication device, among the at least two second telecommunication devices, is involved in the transfer of the group of data through the link according to the determined information,

means for determining at least a weighting vector to be used for the transfer of the group of data, the elements of the weighting vector weighting the signals representatives of the group of data transferred through at least two antennas.

Thus, if the first telecommunication device is aware of any other telecommunication devices which may disturb the transfer of information between the first and the second telecommunication devices, the determination of the weighting vector can be made considering these disturbances.

Furthermore, the first telecommunication device can then control the weighting made by at least one second telecommunication device on the signals transferred between the first telecommunication device and the second telecommunication device.

Such case is particularly effective when the first telecommunication device is a base station and the second telecommunication device is a terminal.

Furthermore, by determining which second telecommunication device, among the at least two second telecommunication devices, is involved in the transfer of the group of data through the link according to information representative of the achievable link conditions between the first telecommunication device and the second telecommunication devices, it is possible to allocate the radio resources of the wireless network in an efficient way.

According to a first advantageous embodiment, the determination of the second device involved in the transfer of the group of data through the link is made also according to the number of antennas of each second telecommunication device.

Thus some priority can be given to second telecommunication devices according to their respective number of antennas.

According to a second advantageous embodiment, each information representative of the achievable link conditions between the first telecommunication device and one second telecommunication device is a matrix representative of the achievable link conditions between the first telecommunication device and the second telecommunication device.

According to a third advantageous embodiment, the modulation and coding scheme to be used by the second telecommunication device involved in the transfer of the group of data are determined.

Thus, the use of the resources of the wireless network is optimized.

Furthermore, as the first telecommunication device determines the modulation and coding scheme to be used by the second telecommunication device involved in the transfer of the group of data, the second telecommunication device doesn't need to comprise complex processing capabilities.

According to a fourth advantageous embodiment, the determination of the modulation and coding scheme to be used by the second telecommunication device involved in the transfer of the group of data is made using the determined weighting vector.

Thus, the determination of the modulation and coding scheme is more accurate and takes profit of the determination of the weighting vector.

According to a fifth advantageous embodiment, the determined second telecommunication device is the second telecommunication device which is expected to receive signals representatives of the group of data transferred by the first telecommunication device.

Thus, the first telecommunication device determines to which second telecommunication device, the group of information should be sent according to each calculated matrices representatives of the achievable link conditions between the first telecommunication device and the second telecommunication device.

According to a sixth advantageous embodiment, the at least one weighting vector to be used for the transfer of the group of data, is a weighting vector which weights the signals representatives of the group of data transferred by the first telecommunication device.

Thus, the first telecommunication device can perform beamforming.

According to a seventh advantageous embodiment, the first telecommunication device comprises N antennas, at most N groups of data are transferred simultaneously through the N antennas, and in that it is determined successively, for each group of data of the at most N groups of data, the second telecommunication device involved in the transfer of the group of data and the weighting vector to be used for the transfer of the group of data.

Thus the determination of the second telecommunication devices is simple and doesn't need any iterative process.

According to a eighth advantageous embodiment, the second telecommunication device involved in the transfer of a group of data is determined by:

calculating a matrix Uₙ using the following formula:

$${U}_{n} = ( I - {\sum }_{l = 1}^{n - 1} {w}_{lD} {w}_{lD}^{H} ) ,$$

wherein I is the identity matrix, n is the identifier of the group of data for which the control of the transfer of the signals representatives of the group of data is currently done, l=1 to n−1 are the identifiers of the groups of data for which the control of the transfer of the signals representatives of the group of data is already done, w_{lD} is the weighting vector which weights the signals transferred by the first telecommunication device determined for the l-th group of data, ( )^{H} is the complex conjugate transpose of ( ),

calculating, for each second telecommunication device k, with k=1 to K, K is the number of second telecommunication devices, a matrix Rₖₙ which is the correlation matrix of interference and noise components for the second telecommunication device k,

$${R}_{kn} = {\sum }_{l = 1}^{n - 1} {P}_{s}^{( l )} {H}_{k} {w}_{lD} {w}_{lD}^{H} {H}_{k}^{H} + {P}_{kz} I ,$$

where Pₛ^{(l)} is the power of the signal transferred by the first telecommunication device through its N antennas for the l-th group of data, Hₖ is the channel matrix between the second telecommunication device k and the first telecommunication device, P_{kz} is the noise power matrix for the second telecommunication devices,

calculating, for each second telecommunication device k, a matrix ψₖₙ=Uₙ^{H}Hₖ^{H}Rₖₙ⁻¹HₖUₙ which is representative of the achievable link conditions between the first telecommunication device and the second telecommunication device k,

determining among the K second telecommunication devices, the second telecommunication device \hat{k} as one involved in the transfer of the group of data which satisfies the following formula:

\hat{k}=argₖ max fₖ(ρ<ψₖₙ>), where ρ<.> is the largest eigenvalue of the matrix <.>, argₖ max represents the second telecommunication device k which has the largest value of fₖ (ρ<ψₖₙ>), fₖ ( ) is a priority function.

Thus, the determination of each second telecommunication device is made without complex calculation and/or without any iteration process.

According to a ninth advantageous embodiment, the priority function fₖ ( ) is the identity function or a function which weights the largest eigenvalue of the matrix ψₖₙ by an averaged Signal to Noise Ratio over a long period of time or a wide frequency band or by the number of antennas of the second telecommunication device.

Thus, when the priority function fₖ ( ) is the identity function, the determination of the second telecommunication device is made using only the largest eigenvalue of the calculated matrices. Using only the largest eigenvalue, the present invention enables the determination of each second telecommunication device which enables to reach a high achievable signal to noise plus interference power ratio for each of the determined second telecommunication device.

Furthermore, using the averaged Signal to Noise Ratio or the number of antennas of the second telecommunication device, it is possible to determine the second telecommunication device according to other criterion.

According to a tenth advantageous embodiment, the weighting vector which weights the signals representatives of the group of data is determined for each group of data according to the following formula:

w_{nD}=e<ψₖₙ>, where e<ψₖₙ> is the eigenvector corresponding to the largest eigenvalue of the matrix ψₖₙ of the second telecommunication device involved in the transfer of the n-th group of data.

Thus, the achievable signal to noise plus interference power ratio of each determined second telecommunication device is maximized.

According to a eleventh advantageous embodiment, an achievable signal to noise plus interference power ratio is determined, for each determined second telecommunication device which is expected to receive signals representatives of the group of data, from the determined weighting vector which weights the signals representatives of the group of data transferred to the second telecommunication device.

According to a twelfth advantageous embodiment which may be used in combination with any of the first to fifth embodiments, the determined second telecommunication device is the second telecommunication device which is expected to transfer signals representatives of the group of data to the first telecommunication device.

Thus, the first telecommunication device determines which second telecommunication device should send the group of information according to each calculated matrices representative of the achievable link conditions between the first telecommunication and the second telecommunication device.

According to a thirteenth advantageous embodiment, the at least one weighting vector to be used for the transfer of the group of data, is a weighting vector which weights the signals representatives of the group of data transferred by the second telecommunication device.

Thus, the second telecommunication device can perform beamforming.

According to a fourteenth advantageous embodiment, the first telecommunication device comprises N antennas, at most N groups of data are received simultaneously through the N antennas, and in that it is determined successively, for each group of data of the at most N groups of data, the second telecommunication device involved in the transfer of the group of data and the weighting vector to be used for the transfer of the group of data.

Thus the determination of the second telecommunication devices is simple and doesn't need any iterative process.

According to a fifteenth advantageous embodiment, the second telecommunication device involved in the transfer of a group of data is determined by:

calculating the correlation matrix Rₙ of interference and noise components which is given by:

$${R}_{kn} = {\sum }_{l = 1}^{n - 1} {P}_{s}^{( l )} {H}_{k ( l )}^{T} {v}_{lU} {v}_{lU}^{H} {H}_{k ( l )}^{*} + {R}_{IN} ,$$

where n is the identifier of the group of data for which the control of the transfer of the signals representatives of the group of data is currently done, l=1 to n−1 are the identifiers of the groups of data for which the control of the transfer of the signals representatives of the groups of data is already done, v_{lU} is the weighting vector which weights the signals representatives of the group of data transferred by the second telecommunication device k determined for the l-th group of data, with k=1 to K, K is the number of second telecommunication devices, ( )^{T} is the transpose of ( ), ( )^{H} is the complex conjugate transpose of ( ), Hₖ is the channel matrix between the second telecommunication device k and the first telecommunication device, Hk₍ₗ₎ is the channel matrix between the second telecommunication device k which has already been determined to send the l-th group of data and the first telecommunication device, ( )* is the complex conjugate of ( ), R_{IN}=E└z_{IN}(p)z_{IN}^{H}(p)┘, z_{IN}(p)=[z₁(p), . . . , z_{Mk}(p)] is the interference plus noise components of the first telecommunication device and p is the p-th received sample, Pₛ^{(l)} is the power of the signal transferred by the second telecommunication device through its N antennas for the l-th group of data,

calculating, for each second telecommunication device k, a matrix H*ₖRₙ⁻¹Hₖ^{T} which is representative of the achievable link conditions between the first telecommunication device and the second telecommunication device k,

determining among the K second telecommunication devices, the second telecommunication device \hat{k} as the one involved in the transfer of the group of data which satisfies the following formula:

\hat{k}=argₖ max fₖ(ρ<H*ₖRₙ⁻¹Hₖ^{T})), where ρ<.> is the largest eigenvalue of the matrix <.>, argₖ max represents the second telecommunication device k which has the largest value of fₖ( ), fₖ(ρ<H*ₖRₙ⁻¹Hₖ^{T}>) is a priority function.

Thus, the determination of the second telecommunication devices is determined without complex calculation and/or without any iteration process.

According to a sixteenth advantageous embodiment, the weighting vector which weights the signals representatives of the group of data is determined for each group of data according to the following formula:

v_{nU}=e<H*ₖRₙ⁻¹Hₖ^{T}), where e<H*ₖRₙ⁻¹Hₖ^{T}> is the eigenvector corresponding to largest eigenvalue of the matrix H*ₖRₙ⁻¹Hₖ^{T} of the second telecommunication device involved in the transfer of the n-th group of data.

Thus, the achievable signal to noise plus interference power ratio of each determined second telecommunication device is maximized.

According to a seventeenth advantageous embodiment, an achievable signal to noise plus interference power ratio is further determined, for each determined second telecommunication device, from the determined weighting vector which weights the signals representatives of the group of data transferred to the second telecommunication device.

According to a eighteenth advantageous embodiment, which is used in combination with the fifth embodiment, two weighting vectors are determined, a weighting vector W_{nD} which weights the signals representatives of the group of data transferred by the first telecommunication device and a weighting vector v_{nD} which weights the signals representatives of the group of data received by the second telecommunication device.

Thus, the first and second telecommunication devices can perform beamforming.

According to a nineteenth advantageous embodiment, the second telecommunication device involved in the transfer of a group of data is determined by:

calculating a matrix B̅ₙ=└Hₖ₍ₗ₎v_{lD,}, . . . ,Hₖ₍ₙ₋₁₎v_{(n-1)D,}┘, n is the identifier of the group of data for which the control of the transfer of the signals representatives of the group of data is currently done, l=1 to n−1 are the identifiers of the groups of data for which the control of the transfer of the signals representatives of the group of data is already done where Hₖ₍ₗ₎ is the channel matrix of the second telecommunication k which is expected to receive signals representatives of the l-th group of data transferred by the first telecommunication device, v_{lD} is the weighting vector which weights the signals representatives of the group of data determined for the l-th group of data,

calculating a matrix Φₙ=I− B̅ₙ( B̅ₙ^{H} B̅ₙ)⁻¹ B̅^{H}, where I is the identity matrix,

calculating, for each second telecommunication device k, k=1 to K, K is the number of second telecommunication devices, a matrix H*ₖΦₙ⁻¹Hₖ^{T} which is representative of the achievable link conditions between the first telecommunication device and the second telecommunication device k,

determining among the K second telecommunication devices, the second telecommunication device \hat{k} as the one involved in the transfer of the group of data which satisfies the following formula:

$$\hat{k} = {arg}_{k} max \frac{{P}_{s}}{{P}_{kz}} {f}_{k} ρ 〈 {H}_{k}^{*} {Φ}_{n} {H}_{k}^{T} 〉 ,$$

where ρ<.> is the largest eigenvalue of the matrix <.>, argₖ max represents the second telecommunication device k which has the largest value of

$$\frac{{P}_{s}}{{P}_{kz}} ρ 〈 {H}_{k}^{*} {Φ}_{n} {H}_{k}^{T} 〉 ,$$

fₖ is a priority coefficient, Pₛ is the power of the signals transferred by the first telecommunication device and P_{kz} is the noise power matrix for the second telecommunication devices.

Thus, the determination of the second telecommunication devices is determined without complex calculation and/or without any iteration process.

According to a twentieth advantageous embodiment, the weighting vector v_{nD} which weights the signals representatives of the group of data transferred by the second telecommunication device is calculating using the following formula: v_{nD}=e<H*ₖΦₙHₖ^{T}>, where e<H*ₖΦₙHₖ^{T}> is the eigenvector corresponding to the largest eigenvalue of the matrix H*ₖΦₙHₖ^{T} of the second telecommunication device involved in the transfer of the n-th group of data.

According to a twenty-first advantageous embodiment, each weighting vector w_{nD} which weights the signals transferred by the first telecommunication device to the determined second telecommunication device for the n-th group of data is calculating using the following formula: \sqrt{Pₛ}[w_{lD}, . . . , w_{n max D}]=P′{(BB^{H})⁻¹B}*,

where P′=diag└\sqrt{Pₛ^{′(1)}}, \sqrt{Pₛ^{′(2)}}, . . . , \sqrt{Pₛ^{′(n max)}}┘,

B=[b₁, . . . ,b_{n max}],

bₗ=Hₖ₍ₗ₎^{T}v_{lD} for l=1 to nmax with ∥v_{lD∥=}1 and nmax is the number of group of data transferred simultaneously.

According to still another aspect, the present invention concerns a computer program which can be directly loadable into a programmable device, comprising instructions or portions of code for implementing the steps of the method according to the invention, when said computer programs are executed on a programmable device.

Since the features and advantages relating to the computer program are the same as those set out above related to the method and device according to the invention, they will not be repeated here.

The characteristics of the invention will emerge more clearly from a reading of the following description of an example embodiment, the said description being produced with reference to the accompanying drawings, among which:

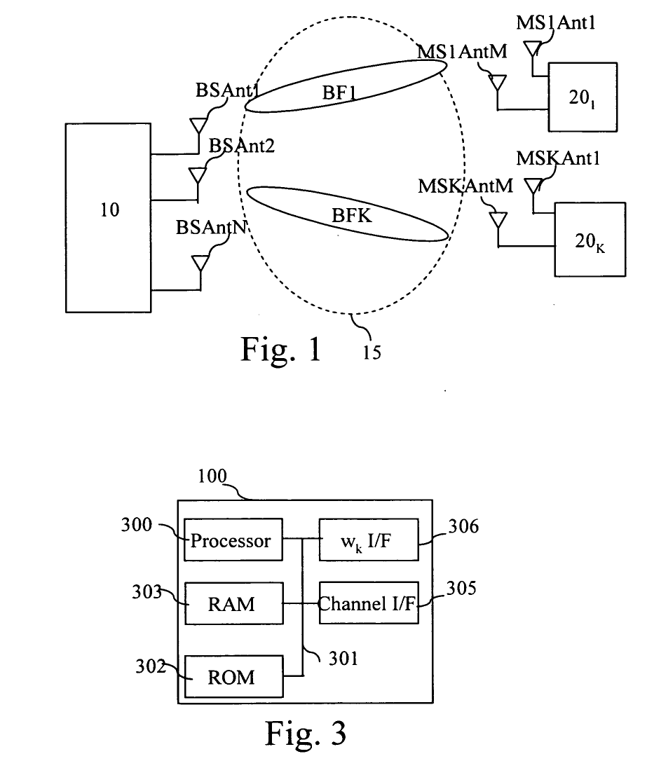

FIG. 1 is a diagram representing the architecture of the system according to the present invention;

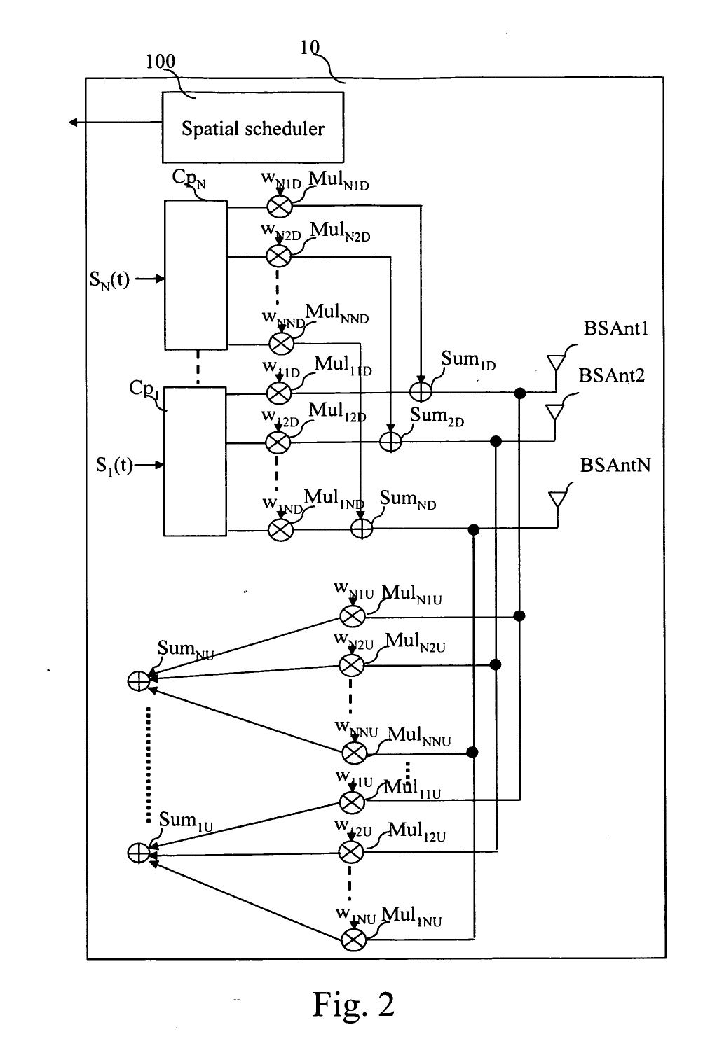

FIG. 2 is a diagram representing the architecture of a base station according to the present invention;

FIG. 3 is a diagram representing the architecture of the spatial multiplexer of the base station according to the present invention;

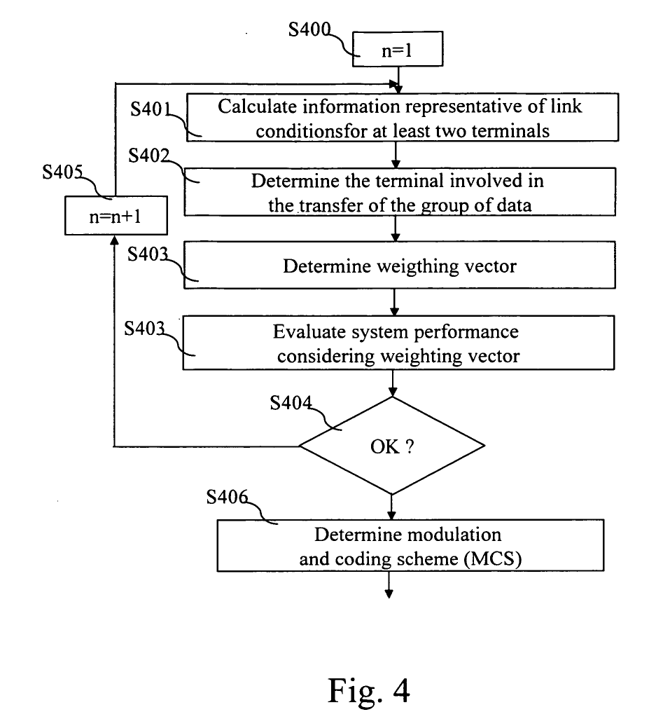

FIG. 4 is an algorithm executed by the base station which describes the general principle of the present invention;

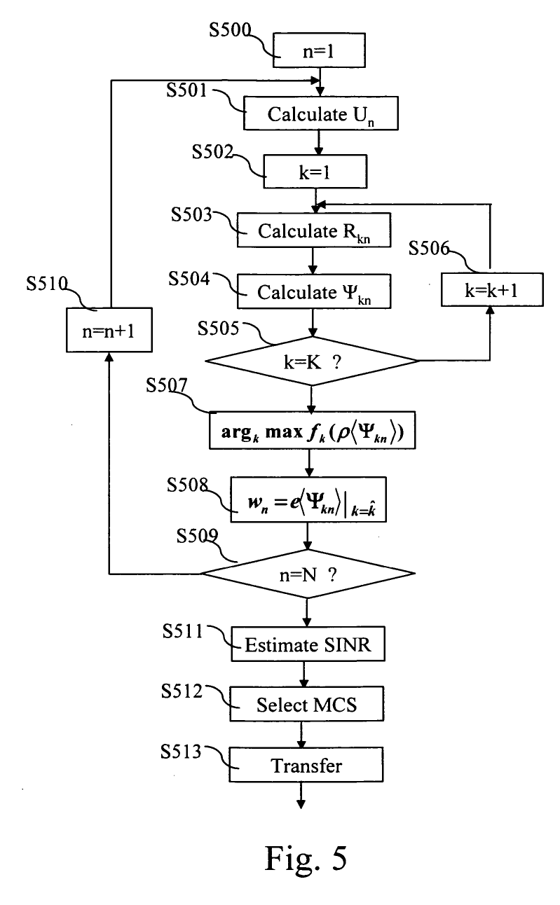

FIG. 5 is an algorithm executed by the base station in order to determine a spatial multiplexing on the downlink channel according to a first mode of realisation of the present invention;

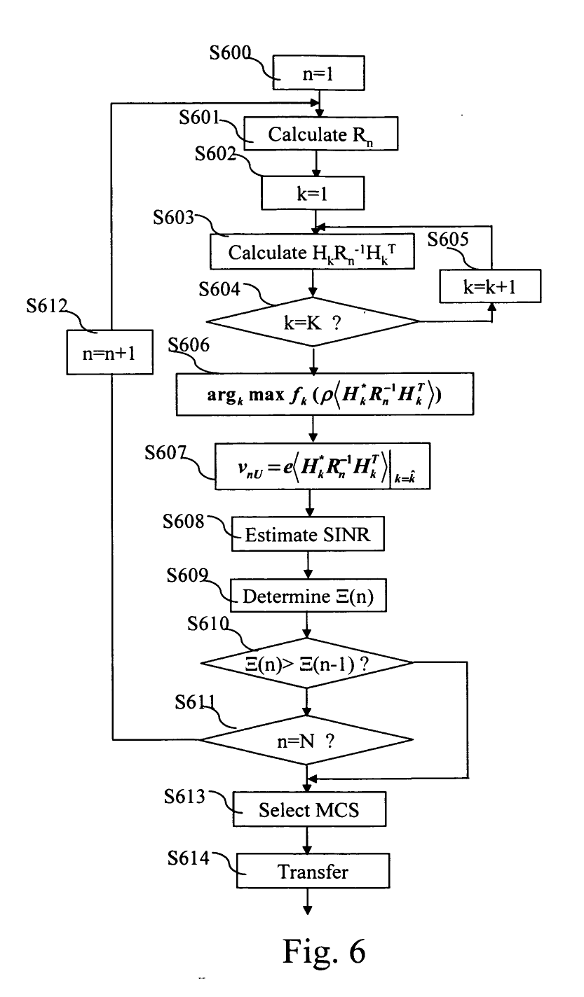

FIG. 6 is an algorithm executed by the base station in order to determine the spatial multiplexing on the uplink channel according to a first mode of realisation of the present invention;

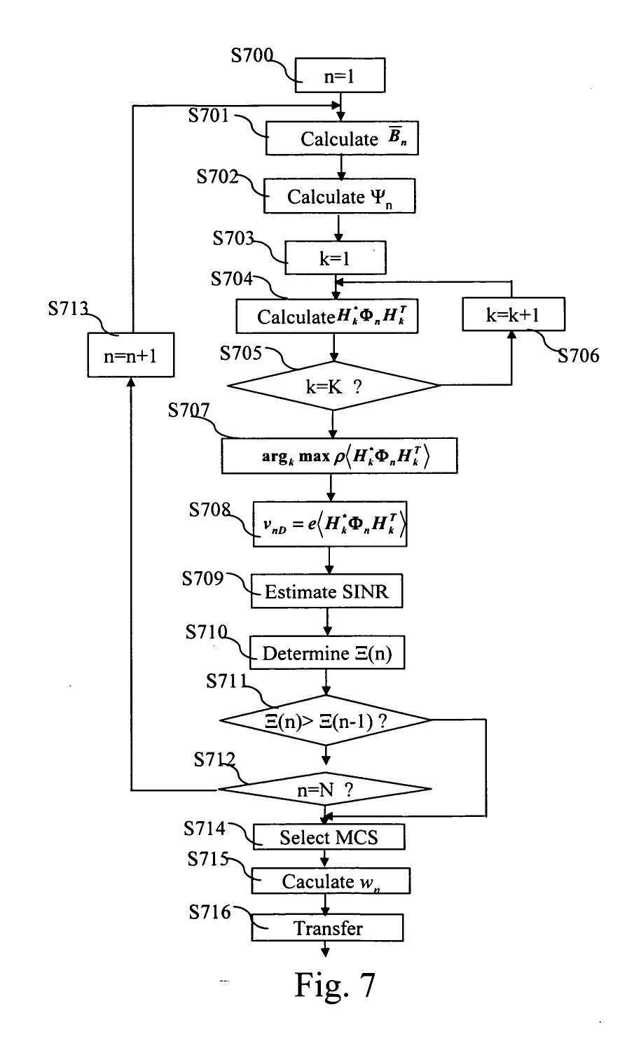

FIG. 7 is an algorithm executed by the base station in order to determine the spatial multiplexing on the downlink channel according to a second mode of realisation of the present invention.

FIG. 1 is a diagram representing the architecture of the system according to the present invention.

In the system of the FIG. 1, a plurality of second telecommunication devices 20₁ to 20_{K} are linked through a wireless network 15 to a first telecommunication device 10 using an uplink and a downlink channel.

Preferably, and in a non limitative way, the first telecommunication device 10 is a base station 10 or a node of the wireless network 15. The second telecommunication devices 20₁ to 20_{K} are terminals like mobile phones or personal computers.

The base station 10 has N antennas noted BSAnt1 to BSAntN. The terminals 20₁ to 20_{K} have Mₖ antennas noted respectively MSAnt1 to MSAntM and MSKAnt1 to MSKAntM. It has to be noted here that the number of Mₖ antennas may vary according to each terminal 20ₖ with k-1 to K. At least one of the terminals 20₁ to 20_{K} has at least two antennas.

The base station 10 transfers signals representatives of a group of data to the terminals 20₁ to 20_{K} through the downlink channel and the terminals 20₁ to 20_{K} transfer signals to the base station 10 through the uplink channel.

When the system uses Time Division Duplexing scheme, the signals transferred in uplink and downlink channels are duplexed in different time periods of the same frequency band. The signals transferred within the wireless network 15 share the same frequency spectrum. The share spectrum is time divided using repeating frames having a fixed number of time slots. Each time slot is used to transmit either on uplink or downlink signals.

When the system uses Frequency Division Duplexing scheme, the signals transferred in uplink and downlink channels are duplexed in different frequency bands. The spectrum is divided into different frequency bands and the uplink and downlink signals are transmitted simultaneously.

The base station 10 transfers through the antennas BSAnt1 to BsAntN the signals to be transmitted to the terminals 20₁ to 20_{K}. More precisely, when the base station 10 transmits signals representatives of a group of data to a given terminal 20ₖ through the downlink channel, the signals are N times duplicated and each duplicated signal is weighted, i.e. multiplied, by an element of a downlink weighting vector W_{nD} of the base station 10.

The base station 10 receives through the antennas BSAnt1 to BsAntN the signals transmitted by the terminals 20₁ to 20_{K}. More precisely, when the base station 10 receives signals representatives of a group of data from a given terminal 20ₖ with k=1 to K through the uplink channel, each signal received by each of its antennas BSAnt1 to BsAntN is weighted, i.e. multiplied, by an element of an uplink weighting vector w_{nU} of the base station 10.

According to the invention, the weighting vectors w_{nD}, and/or w_{nU}, are determined by the base station 10 for each of the n groups of data received simultaneously, where n=1 to at most N, to be transferred or received by the base station 10. As a result, the base station 10 and each terminal 20ₖ performs beamforming, i.e. controls the spatial direction of the transmitted or received signals.

The ellipse noted BF1 in the FIG. 1 shows the pattern of the radiated signals by the antennas BSAnt1 to BSAntN transferred to the terminal 20₁ by the base station 10.

The ellipse noted BFK in the FIG. 1 shows the pattern of the radiated signals by the antennas BSAnt1 to BSAntN transferred to the terminal 20_{K} by the base station 10.

The base station 10 further determines the weighting vectors v_{nD} and/or v_{nU}, with n=1 to nmax, that each terminal 20ₖ, where k=1 to K, has to use for weighting the signals representatives of group of data, received and/or transmitted through the antennas MSkAnt1 to MSkAntM. The base station 10 transfers to a given terminal 20ₖ the weighting vectors v_{nD} and/or v_{nU} by transferring the elements of weighting vector v_{nD} and/or v_{nU} within a group of data.

It has to be noted here that, in a variant of realization, the base station 10 doesn't transfer the weighting vectors v_{nD} to the terminals 20. Each terminal 20ₖ determines by itself the downlink weighting vector it uses.

In another variant of realisation, the base station 10 transfers to the terminal 20ₖ which is determined to transfer a group of information n the determined information related to the weighting vector v_{nU}, and transfers to the terminal 20ₖ through the wireless network 15 at least a signal being weighted by the information related to the determined weighting vector v_{nU}.

More precisely, each weighting vector v_{nD} is determined for each group of data n to be transferred simultaneously in the downlink channel or each weighting vector v_{nU} is determined for each group of data n to be transferred simultaneously in the uplink channel.

Then, each terminal 20ₖ transfers, through its antennas MSkAnt1 to MSkAntM, the signals representatives of a group of data to be transmitted to the base station 10. More precisely, when a terminal 20ₖ transmits signals representatives of a group of data to the base station 10 through the uplink channel, the signals are Mₖ times duplicated and each duplicated signal is weighted, i.e. multiplied, by an element of an uplink weighting vector v_{nU} determined for the terminal 20ₖ which is determined to receive the n-th group of data.

The ellipse BF1 shows the pattern of the radiated signals by the antennas MSIAnt1 to MSIAntM transferred by the terminal 20, to the base station 10.

The ellipse BFK shows the pattern of the radiated signals by the antennas MSKAnt1 to MSKAntM transferred by the terminal 20_{K} to the base station 10.

Each terminal 20ₖ receives, through its antennas MSkAnt1 to MSkAntM, signals transmitted by the base station 10. More precisely, when a terminal 20ₖ receives signals from the base station 10 through the downlink channel, each signal received by each of its antennas MSkAnt1 to MSkAntM is weighted, i.e. multiplied, by an element of the determined downlink weighting vector v_{nD} for the terminal 20ₖ which is determined to receive the n-th group of data.

As a result, the terminal 20ₖ performs beamforming, i.e. controls the spatial direction of the received signals from the base station 10.

According to the variant of realization, each terminal 20ₖ determines by itself the downlink weighting vector it has to use.

According to the other variant of realization, each terminal 20ₖ receives from the base station 10 plural signals through the downlink channel and calculates from the received signals the weighting vector v_{nD} it has to use when it receives signals from the base station 10 through the downlink channel. Each terminal 20ₖ receives from the base station 10 plural signals through the downlink channel and calculates from the received signal or signals the weighting vector v_{nU} it has to use when it transfers signals to the base station 10 through the uplink channel.

FIG. 2 is a diagram representing the architecture of a base station according to the present invention.

The base station 10 comprises a spatial multiplexer 100, N duplication modules noted Cp₁ to CP_{N}, N*N downlink multiplication modules noted MUl_{l1D} to MUl_{NND}, N downlink summation modules noted Sum_{lD} to Sum_{ND}, N*N uplink multiplication modules noted Mul_{l1U} to Mul_{NNU}, N uplink summation modules noted Sum_{lU} to Sum_{NU}.

According to the invention, the base station 10 transfers simultaneously, through the downlink channel, at most N groups of data. The spatial multiplexer 100 determines information which are representative of the achievable link conditions between the base station 10 and each terminal 20ₖ. The spatial multiplexer 100 determines, for each of the at most N groups of data, the terminal 20ₖ which has to receive the group of data according to the determined information which are representative of the achievable link conditions. The base station 10 receives simultaneously, through the uplink channel, nmax groups of data with nmax≦N. The spatial multiplexer 100 determines, for each of the nmax groups of data to be received, the terminal 20ₖ which has to transfer the group of data to the base station 10 according to the determined information representative of the achievable link conditions.

The signals S₁(t) to S_{N}(t) are the signals, which are respectively representative of N groups of data, to be transferred to the K terminals 20₁ to 20_{K} linked to the base station 10. Each of the signals S₁(t) to S_{N}(t) are N times duplicated by a respective duplication module Cp₁ to CP_{N}. For each signal to be transferred to a terminal 20ₖ with k=1 to K, each duplicated signal is weighted by the elements of a downlink weighting vector w_{nD} corresponding to the group of data noted n to be transferred to the terminal 20ₖ and determined by the spatial multiplexer 100. The combination of each signals transferred to a terminal 20ₖ by the antennas BSAnt1 to BSAntN is called beamforming signal.

The signals weighted by the first element of each downlink weighting vector w_{nD} of the base station 10 are then summed and transferred through the first antenna BSAnt1 of the base station 10. The signals weighted by the second element of each weighting vector w_{nD} of the base station 10 are then summed and transferred through the second antenna BSAnt2 of the base station 10 and so on until the N-th elements of the weighting vector w_{nD} of the base station 10.

It has to be noted here that the signals are prior to be transferred to each antenna BSAnt1 to BSAntN, frequency up converted, mapped and so on, as it is done in classical wireless telecommunication devices.

The base station 10 receives simultaneously nmax, with n max≦N signals which are representative of nmax groups of data transferred by at least a part of the K terminals 20₁ to 20_{K}. The signals received by each antenna BSAnt1 to BSAntN are respectively weighted, i.e. multiplied by the elements of an uplink weighting vector w_{nU} of the base station 10.

Each signal received through the antenna BSAnt1 is N times multiplied by the first elements (w_{l1U}, . . . w_{nmax1U}) of the uplink weightings vectors w_{lU} to w_{nmaxU} of the base station 10.

Each signal received through the antenna BSAnt2 is N times multiplied by the second elements (w_{l2U}, . . . w_{nmax2U}) of the uplink weightings vector w_{lU} to w_{nmaxU} of the base station 10.

Each signal received through the antenna BSAntN is N times multiplied by the N-th elements (w_{lNU}, . . . w_{nmaxNU}) of the uplink weightings vector w_{lU} to w_{nmaxU} of the base station 10.

The signals weighted by the uplink weighting vector w_{lU} of the base station 10 are then added by a by an adder noted Sum_{lU} in order to form the first received group of data.

The signals weighted by the uplink weighting vector w_{NU} of the base station 10 are then added by a by an adder noted Sum_{NU} in order to form the N-th received group of data.

It has to be noted here that the signals received from each antenna BSAnt1 to BSAntN are frequency down converted, demapped and so on, as it is done in classical wireless telecommunication devices.

FIG. 3 is a diagram representing the architecture of the spatial multiplexer of the base station according to the present invention.

The spatial multiplexer 100 of the base station 10 has, for example, an architecture based on components connected together by a bus 301 and a processor 300 controlled by programs as disclosed in the FIGS. 4, 5, 6 or 7.

The bus 301 links the processor 300 to a read only memory ROM 302, a random access memory RAM 303, a vector interface 306 and a channel interface 305.

The memory 303 contains registers intended to receive variables, and the instructions of the programs related to the algorithm as disclosed in the FIGS. 4, 5, 6 or 7.

The processor 300 determines the downlink weighting vectors w_{1D} to w_{ND} of the base station 10, the uplink weighting vectors w_{lU} to w_{NU} of the base station 10, the downlink weighting vectors v_{lD} to v_{ND} of the terminals 20₁ to 20_{K} which have been determined to receive each group n of data with n=1 to N and the uplink weighting vectors v_{lU} to v_{NU} of the terminals 20ₖ to 20_{K} which have been determined to transmit each group n of data 10 with n=1 to nmax where nmax is ≦N.

The read only memory 302 contains instructions of the programs related to the algorithm as disclosed in the FIGS. 4, 5, 6 or 7 which are transferred, when the base station 10 is powered on to the random access memory 303.

The vector interface 306 enables the transfer of the downlink weighting vectors w_{lD} to w_{ND} of the base station 10 to the respective multipliers MUl_{l1D} to MUl_{NND}.

The vector interface 306 enables the transfer of the uplink weighting vectors w_{lU} to w_{NU} of the base station 10 to the respective multipliers Mul_{l1U} to Mul_{NNU}.

The vector interface 306 enables also the transfer of the downlink and uplink weighting vectors v_{lD} to v_{ND}, v_{IU} to v_{NU} to be used by the terminals 20ₖ in order to receive or transfer at least a group of data according to the invention.

Such downlink and uplink weighting vectors v_{lD} to v_{ND}, v_{lU} to v_{NU} are transferred to the respective terminals 20 within at least a group of data or, by determining downlink weighting vectors of the base station 10 which are related to the weighting vector v_{lD} to v_{ND} or v_{lU} to v_{NU}.

According to a variant of realisation, the weighting vector v_{lD} to v_{ND} are not transferred by the base station 10.

The base station 10 transfers then at least nmax pilot signals which are weighted by the downlink weighting vectors w_{lD} to w_{ND} of the base station 10 which are related to the weighting vectors v_{lD} to v_{ND} or v_{lU} to v_{NU}. Each determined terminal 20 receives at least a pilot signal from the base station 10, determines from the at least one received pilot signal, the downlink weighing vector v_{nU} or v_{nU} it has to use for weighting the signals representatives of the n-th group of data.

The channel interface 305 is adapted for receiving pilot signals from the terminals 20₁ to 20_{K} and to perform an estimation of link conditions or in other words to perform, for each terminal 20ₖ, an estimation of the channel response matrix between the terminal 20ₖ and the base station 10.

FIG. 4 is an algorithm executed by the base station which describes the general principle of the present invention.

The present algorithm is executed each time the base station 10 has to transfer simultaneously at most N groups of data to at least one of the terminals 20₁ to 20_{K}.

At step S400, the base station 10 sets a variable noted n to 1. The variable n denotes the group of data under process.

At next step S401, the base station 10 calculates at least two information, each information being representative of the achievable link conditions between the base station and one terminal 20ₖ with k=1 to K.

At next step S402, the base station 10 determines, which terminal 20ₖ among the at least two terminals 20, is involved in the transfer of the group of data through the link according to the determined information.

At next step S403, the base station 10 determines at least a weighting vector to be used for the transfer of the group of data, the elements of the weighting vector weighting the signals representatives of the group of data transferred through at least two antennas.

At next step S403, the base station 10 determines the system evaluation function for the group of data under process considering the at least one determined weighting vector at step S403.

At next step S404, the base station 10 determines the system evaluation function for the group is acceptable or not.

If the system evaluation function for the group of data is acceptable, the base station 10 moves to step S405, increments the variable n of one unit and returns to step S401 in order to consider the next group of data.

If the system evaluation function for the group of data is not acceptable, nmax group of data will be transferred simultaneously with nmax=n−1. The base station 10 moves to step S406 and selects, for each determined terminal 20, a modulation and coding scheme to be used for the transfer of the group of data of which they are involved in the transfer.

FIG. 5 is an algorithm executed by the base station in order to determine a spatial multiplexing on the downlink channel according to a first mode of realisation of the present invention.

The present algorithm is executed each time the base station 10 has to transfer simultaneously N groups of data to at least one of the terminals 20₁ to 20_{K}.

The base station 10 transfers simultaneously, through its N antennas, N groups of data. The base station 10 calculates information representative of the achievable link conditions between the base station 10 and each of the K terminals 20₁ to 20_{K} and determines which terminal 20 or terminals 20 has or have to receive at least a group of data according to the determined information.

According to the first mode of realisation of the invention, the base station 10, determines for each transferred group of data n, where n=1 to N is the indicia of a group of data, a downlink weighting vector w_{nD} of the base station 10.

More precisely the present algorithm is executed by the processor 300 of the spatial multiplexer 100 of the base station 10.

At step S500, the processor 300 sets a variable noted n to 1. The variable n denotes the group of data under process.

At next step S501, the processor 300 calculates the matrix Uₙ using the following formula:

$${U}_{n} = ( I - {\sum }_{l = 1}^{n - 1} {w}_{lD} {w}_{lD}^{H} ) ,$$

wherein I is the identity matrix, w_{lD}, for l=1 to n−1, are the downlink weighting vectors of the base station 10 determined for the first to n−1 groups of data previously processed, w_{lD}^{H} is the complex conjugate transpose of downlink weighting vector of the base station 10 w_{lD}.

It has to be noted here that the downlink weighting vector w_{ND} of the base station 10 are mutually orthogonal.

At next step S502, the processor 300 sets the variable k to one. The variable k denotes an indicia of the terminal 20ₖ under process.

At next steps S503 and S504, the processor 300 determines a matrix representative of the achievable link conditions for the terminal 20ₖ.

More precisely, the processor 300 determines at step S503, the matrix noted Rₖₙ which is the correlation matrix of interference and noise components for the terminal 20ₖ under process and the group of data n under process. Rₖₙ is given by:

$${R}_{kn} = {\sum }_{l = 1}^{n - 1} {P}_{s}^{( l )} {H}_{k} {w}_{lD} {w}_{lD}^{H} {H}_{k}^{H} + {P}_{kz} I .$$

Pₛ^{(l)} is the power of the signal transferred by the base station 10 through its antennas BSAnt1 to BSAntN.

Hₖ is the channel matrix between the terminal 20ₖ and the base station 10, P_{kz} is the noise power matrix for the terminals 20.

The base station 10 has knowledge of the channel matrix Hₖ and the noise power P_{kz}. Classically, each channel matrix Hₖ is obtained by measuring the complex amplitude of pilot signals transmitted individually by the terminal 20ₖ on the uplink channel. The interference-plus-noise power P_{kz} is reported by the terminal 20ₖ on the uplink channel. It has to be noted here that, instead of reporting the interference-plus-noise power P_{kz}, each the terminal 20ₖ reports other relevant parameters such as the signal to noise plus interference power ratio or any other channel quality indicators, from which the base station 10 can estimate the noise power P_{kz}. In a variant of realization the base station 10 uses presumable values of the interference-plus-noise power P_{kz} instead of determining them from the reported values by the terminals 20.

At step S504, the processor 300 calculates the matrix noted ψₖₙ representative of the achievable link conditions between the terminal 20ₖ and the base station 10 using the following formula:
ψₖₙ=Uₙ^{H}Hₖ^{H}Rₖₙ⁻¹HₖUₙ.

At next step S505, the processor 300 checks whether or not the variable k is equal to K. If k is different from K, the processor 300 moves to step S506 and increment the variable k of one and returns to step S503 already described.

The processor 300 executes the loop comprising the steps S503 to S505 as far as a matrix representative of the achievable link conditions between each terminal 20ₖ and the base station 10 is determined.

Once a matrix representative of the achievable link conditions is determined for each terminal 20ₖ, the processor 300 moves to step S507.

The steps S501 to S506 correspond to the determination of K matrices, each matrix being representative of the achievable link conditions between the base station 10 and a terminal 20ₖ.

At step S507, the processor 300 determines the terminal 20ₖ to which the n-th group of data under process has to be sent as the one which has the largest achievable signal to noise plus interference power ratio (SINR).

More precisely, the processor 300 determines, for the n-th group of data, the terminal noted \hat{k} which satisfies the following formula:

\hat{k}=argₖ max fₖ(ρ<ψₖₙ>), where ρ<.> is the largest eigenvalue of the matrix <.>, argₖ max represents the terminal 20ₖ which has the largest value of fₖ(ρ<ψₖₙ>) and fₖ ( ) is a priority function.

Preferably, fₖ( ) is the identity function.

In a first variant of realisation, fₖ( ) is equal to:

$${f}_{k} ( ρ ( {Ψ}_{kn} ) ) = \frac{ρ ( {Ψ}_{kn} )}{{avgSNR}_{k}} ,$$

where avgSNRₖ is the averaged Signal to Noise Ratio (SNR) over a long period of time or a wide frequency band.

In a second variant of realisation, fₖ( ) is equal to:

$${f}_{k} ( ρ ( {Ψ}_{kn} ) ) = \frac{ρ ( {Ψ}_{kn} )}{{M}_{k}} ,$$

where Mₖ is the number of antennas of the terminal 20ₖ.

It has to be noted here that, many different functions fₖ( ) can be used in the present invention. Such function fₖ( ) introduces some priority, according to certain criterion or criteria, in the determination of the terminal 20 to which the n-th group of data under process has to be sent.

At next step S508, the processor 300 determines the downlink weighting vector of the base station 10 w_{nD} for the group of data n under process using the following formula:

w_{nD}=e<ψ_{kn>|}_{k=\hat{k}}, where e<ψₖₙ> denotes the eigenvector corresponding to largest the eigenvalue of the matrix ψₖₙ of the terminal \hat{k} determined at step S507.

Thanks to steps S507 and S508, the processor 300 determines the terminal \hat{k} which has to receive the n-th group of data and selects, for n-th group of data, the downlink weighting vector w_{nD} of the base station 10 which maximizes the SINR of the terminal \hat{k}.

It has to be noted here that, if we consider that the n-th group of data is sent to the k-th terminal in the presence of an n−1-th group of data which has been previously determined by the spatial multiplexer 100, the k-th terminal's received signal is expressed as:
xₖₙ(p)=aₖₙsₙ(p)+zₖₙ^{(IN)}(p)
where aₖₙ=\sqrt{Pₛ⁽ⁿ⁾}Hₖw_{nD}, (IN) means interference plus noise and zₖₙ^{(IN)}(p) is the interference plus noise for the p-th sample of the received signal.

$${Z}_{kn}^{( IN )} ( p ) = {\sum }_{l = 1}^{n - 1} {H}_{k} {w}_{lD} \sqrt{{P}_{s}^{( l )}} {s}_{1} ( p ) + {z}_{k} ( p )$$

where zₖ(p)=└zₖ₁(p), . . . z_{kM}_{ₖ}(p)┘^{T} is the Mₖ×1 interference plus noise vector at the terminal 20ₖ with a power P_{kz}(E└zₖ(p)zₖ(p)^{H}┘=P_{kZ}I).

The terminal 20ₖ applies the weighting vector v_{nD}=(Rₖₙ⁻¹aₖₙ)* for the n-th group of data on each of the M received signals by the antennas MSAnt1 to MSAntM based on the minimum-mean-square-error weight.

Then, the signal to noise plus interference power ratio γₖₙ after weighting is expressed as:

$${γ}_{kn} = \frac{E [ {\vert {v}_{nD}^{T} {a}_{kn} \vert}^{2} ]}{E [ {\vert {v}_{nD}^{T} {z}_{kn}^{( IN )} ( p ) \vert}^{2} ]} = {P}_{S}^{( n )} {w}_{nD}^{H} {H}_{k}^{H} {R}_{kn}^{- 1} {H}_{k} {w}_{nD} .$$

Such formula shows that at step S507, determined terminal 20ₖ is the one which has the largest achievable signal to noise plus interference power ratio among the terminals 20.

As disclosed above, the spatial multiplexer 100 preferably imposes the downlink weighting vectors of the base station 10 determined for two groups of data which are transmitted to two different terminals 20 to be mutually orthogonal. The first to (n−1)-th groups of data being already determined, the n-th weight vector w_{nD} satisfies the following equation:

$${w}_{nD} = {U}_{n} {w}_{nD} with {U}_{n} = ( I - {\sum }_{l = 1}^{n - 1} {w}_{ID} {w}_{ID}^{H} ) .$$

Then, the SINR γₖₙ of the terminal 20ₖ to which the n-th group of data is transferred is equal to
yₖₙ=Pₛ⁽ⁿ⁾w_{nD}^{H}ψₖₙw_{nD} where ψₖₙ=Uₙ^{H}Hₖ^{H}Rₖₙ⁻¹Hₖ^{U}ₙ.

Since the eigenvectors of ψₖₙ which correspond to non-zero eigenvalue are orthogonal to w_{lD}, . . . , w_{(n-1)D}, γₖₙ is maximized to Pₛ⁽ⁿ⁾ρ<ψₖₙ>.

At next step S509, the processor 300 checks if the variable n is equal to N. If n is different from N, the processor 300 moves to step S510, increments the variable n of one and move to step S501 in order to consider the next group of data.

As far as all the N groups of data have not been processed, the processor 300 executes the loop made by the steps S501 to S510.

Once the N groups of data have been processed, the processor 300 moves to step S511.

At next step S511, the processor 300 determines the expected SINR of each of the terminals 20 determined at step S507 as Pₛ⁽ⁿ⁾ ρ<ψₖₙ>|_{k=\hat{k}}.

It has to be noted here that once the n-th group of data is determined, the spatial multiplexer 100 adds the (n+1)-th group of data in the presence of the first to n-th groups of data.

It has to be noted here that the received SFNR of the n-th group of data is not modified after the (n+1)-th group of data is added. In the same manner, the received SINR of the determined group of data is kept even if more groups of data are added by the spatial multiplexer 100.

This characteristic is led by the orthogonality of the downlink weighting vectors w_{nD} of the base station 10 disclosed above. Using this characteristic, the spatial multiplexer 100 decides the downlink weighting vectors w_{nD} of the base station 10 and the terminal 20 which has to receive for the n-th group of data in the sequence n=1, . . . , N without considering the effect of additional groups of data.

At next step S512, the processor 300 determines, for each of the terminals 20 determined at step S507, the modulation and coding scheme to be used by each of the determined terminals 20 for the downlink channel.

At next step S513, the processor 300 transfers the elements of the downlink weighting vectors w₁ to w_{N} of the base station 10 determined at step S508 to the multiplication modules noted Mul_{11D} to Mul_{NND}, transfers the ordered list of the determined terminals 20 at step S507 to an allocation module not shown in the FIG. 3 which selects, for each of the determined terminals 20, a group of data which has a destination address equals to the determined terminal 20.

The groups of data are then transferred by the base station 10.

It has to be noted here that, the information related to the modulation and the coding scheme to be used by determined terminals 20 for the downlink channel are also transferred in a time slot of the downlink channel.

Each of the determined terminal 20 receives pilot signals determines the downlink weighting vector based on the minimum-mean-square-error weight according to the following formula:

v_{nD}=(Rₖₙ⁻¹aₖₙ)* with aₖₙ=\sqrt{Pₛ⁽ⁿ⁾}Hₖw_{nD} on each of the Mₖ received signals by the antennas MSkAnt1 to MSkAntM.

Each terminal 20 checks in the received group of data, the destination terminal identifier. If the identifier corresponds to its one, the terminal 20 identifies the modulation and coding scheme to be used for the downlink channel.

FIG. 6 is an algorithm executed by the base station in order to determine the spatial multiplexing on the uplink channel according to the first mode of realisation of the present invention.

The base station 10 is able to receive simultaneously nmax signals representatives of nmax groups of data through the uplink channel. The base station 10 decides which terminal 20 has to transfer each of the group of data on the uplink channel.

If the terminal 20ₖ is determined to send the n-th group of data, the terminal 20ₖ performs beamforming based on a Mₖ*1 weighting vector v_{nU} transferred by the base station 10.

More precisely the present algorithm is executed by the processor 300 of the spatial multiplexer 100 of the base station 10.

At step S600, the processor 300 sets a variable noted n to 1. The variable n denotes the group of data under process.

At next step S601, the processor 300 calculates the correlation matrix Rₙ of interference and noise components which is given by:

$${R}_{n} = {\sum }_{l = 1}^{n - 1} {P}_{s}^{( l )} {H}_{k ( l )}^{T} {v}_{lU} {v}_{lU}^{H} {H}_{k ( l )}^{*} + {R}_{IN} ,$$

where v_{lU}(l=1 to n−1) are the weighting vectors determined for the terminals 20 which have already been determined to send the first to l-th groups of data on the uplink channel, Hₖ is the channel matrix between the terminal 20ₖ and the base station 10 and Hk₍ₗ₎ is the channel matrix between the second telecommunication device k which has already been determined to send the l-th group of data and the first telecommunication device, ( )* denotes the complex conjugate of ( ), R_{IN}=E[z_{IN}(p)z_{IN}^{H}(p)┘, z_{IN}(p)=[z₁(p), . . . ,z_{Mk}(p)] is the interference plus noise component of the base station 10 and p is the p-th received sample.

It has to be noted here that the base station 10 has knowledge of the channel matrix Hk₍ₗ₎ on the same manner as disclosed for Hₖ in the FIG. 5.

At next step S602, the processor 300 sets the variable k to one. The variable k denotes an indicia of the terminal 20ₖ under process.

At next step S603, the processor 300 calculates the matrix representative of the achievable link conditions between the terminal 20ₖ and the base station 10 using the following formula: H*ₖRₙ⁻¹Hₖ^{T}.

At next step S604, the processor 300 checks whether or not the variable k is equal to K.

If k is different from K, the processor 300 moves to step S605, increments k of one and returns to steps S603.

As far as k is different from K, the processor 300 executes the loop made by the steps S603 to S605.

If k is equal to K, the processor 300 moves to step S606.

The steps S601 to S605 correspond to the determination of K matrices, each matrix being representative of the achievable link conditions between the base station 10 and a terminal 20ₖ.

At step S606, the processor 300 determines the terminal 20ₖ which has to transfer the n-th group of data under process as the one which has the largest achievable signal to noise plus interference power ratio (SINR).

More precisely, the processor 300 determines, for the n-th group of data, the terminal noted \hat{k} which satisfies the following formula:

\hat{k}=argₖ max fₖ(ρ<H*ₖRₙ⁻¹Hₖ^{T}), where ρ<.> is the largest eigenvalue of the matrix <.>, argₖ max represents the terminal 20ₖ which has the largest value of fₖ( ) and fₖ (ρ<H*ₖRₙ⁻¹Hₖ^{T}>) is a priority function.

Preferably, fₖ( ) is the identity function.

In a first variant of realisation, fₖ( ) is equal to

$${f}_{k} ( ρ ( {Ψ}_{kn} ) ) = \frac{ρ ( {H}_{k}^{*} {R}_{n}^{- 1} {H}_{k}^{T} )}{{avgSNR}_{k}} ,$$

where avgSNRₖ is the averaged Signal to Noise Ratio (SNR) over a long period of time or a wide frequency band.

In a second variant of realisation, fₖ( ) is equal to

$${f}_{k} ( ρ ( {Ψ}_{kn} ) ) = \frac{ρ ( {H}_{k}^{*} {R}_{n}^{- 1} {H}_{k}^{T} )}{{M}_{k}} ,$$

where Mₖ is the number of antennas of the terminal 20ₖ.

It has to be noted here that, many different functions fₖ( ) can be used in the present invention. Such function fₖ( ) introduces some priority, according to certain criterion or criteria, in the determination of the terminal 20 to which the n-th group of data under process has to be sent.

At next step S607, the processor 300 determines the uplink weighting vector v_{nU} of the determined terminal 20 for the group of data n under process using the following formula:

v_{nU}=e<H*ₖRₙ⁻¹Hₖ^{T>|}_{k=\hat{k}}, where e<H*ₖRₙ⁻¹Hₖ^{T}>|_{k=\hat{k}} denotes the eigenvector corresponding to largest the eigenvalue of the matrix H*ₖRₙ⁻¹Hₖ^{T} of the terminal \hat{k} determined at step S606.

Thanks to steps S606 and S607, the processor 300 determines the terminal \hat{k} which has to transfer the n-th group of data and selects an uplink weighting vector v_{nU} for the determined terminal 20 and for the group of data n under process which maximizes the SINR of the terminal \hat{k}.

The signal to be weighted prior to be transferred by the determined terminal 20 sₙ(p) which is related to the n-th group of data, has a power Pₛ⁽ⁿ⁾ and E└|s_{b}(p)|²=1┘. The p-th sample x_{BS}(p)=[x_{BS,l}(p), . . . ,x_{BS,N} (p)]^{T} of the received group of data by the base station 10 is given by:

$${x}_{BS} ( p ) = {\sum }_{n = 1}^{n max} {H}_{k ( n )}^{T} \sqrt{{P}_{s}^{( n )}} {v}_{nU} {s}_{n} ( p ) + {z}_{IN} ( p ) ,$$

where k(n) is the terminal's identifier which is determined to send the n-th group of data, z_{IN}(p)=[z₁(p), . . . , z_{M}(p)]^{T} is the interference plus noise at the base station 10 with E└z_{IN}(p)z_{IN}^{H}(p)┘=R_{IN}.

Considering that the n-th group of data is sent by the k-th terminal in the presence of the first to (n−1)-th received groups of data, the n-th received group of data by the base station 10 is expressed as:
x_{BS}(p)=bₙsₙ(p)+zₙ(p),
where

$${z}_{n} ( p ) = {\sum }_{l = 1}^{n - 1} {b}_{l} {s}_{l} ( p ) + {z}_{IN} ( p ) ,$$

bₗ=\sqrt{Pₛ^{(l)}}Hₖ₍ₗ₎^{T}v_{lU}, H*ₖ₍ₗ₎ is the channel matrix between the terminal 20ₖ which has to transfer the l-th group of data and the base station 10 on the uplink channel.

The base station 10 performs beamforming on the received signals based on the minimum-mean-square-error weight, using w_{nU}=(Rₙ⁻¹bₙ)* where Rₙ is the correlation matrix calculated at step S601 and bₙ=\sqrt{Pₛ⁽ⁿ⁾}Hₖ₍ₙ₎^{T}v_{nU}.

Then, the signal to noise plus interference power ratio γ_{k→n} after weighting is expressed as:

$${γ}_{k \to n} = \frac{E [ {\vert {w}_{nU}^{T} {b}_{n} \vert}^{2} ]}{E [ {\vert {w}_{nU}^{T} {z}_{n} ( p ) \vert}^{2} ]} = {P}_{S}^{( n )} {v}_{nU}^{H} {H}_{k}^{H} {R}_{n}^{- 1} {H}_{k}^{T} {v}_{nU} .$$

The SINR γ_{k→n} is maximized to Pₛ⁽ⁿ⁾ρ<H*ₖRₙ⁻¹Hₖ^{T}> using v_{nU}=e<H*ₖRₙ⁻¹Hₖ^{T}>.

Such formula shows that at step S606, the determined terminal 20ₖ is the one which has the largest achievable signal to noise plus interference power ratio among the terminals 20.

The n-th group of data may deteriorate the SINRs of previously determined first to (n−1)-th groups of data. The SINRs γ_{l/n} of the l-th group of data with l=1 to n is given by:
γ_{l/n}=bₗ^{H}(Rₙ−bₗbₗ^{H}+bₙbₙ^{H})⁻¹bₗ

At next step S608, the processor 300 estimates the achievable signal to noise plus interference power ratio SINR γ_{l/n}=bₗ^{H}(Rₙ−bₗbₗ^{H}+bₙbₙ^{H})^{-b}ₗ of the determined terminal \hat{k}.

At next step S609, the processor 300 determines a system evaluation function Ξ(n) for the group of data under process.

As example, the system evaluation function Ξ(n) is expressed by the throughput and is equal to

$${\sum }_{l = 1}^{n} T ( {γ}_{l / n} ) ,$$

where T(γ) represents the throughput of a group of data as a function of the received SINR γ.

As example and in a non limitative way, T(γ) is implemented under the form of a lookup table stored in the ROM memory 302 of the base station 10. If the SINR is comprised between zero and one dB, the throughput is equal to 0.250. If the SINR is comprised between one and two dBs, the throughput is equal to 0.285. If the SINR is comprised between two and three dBs, the throughput is equal to 0.333. If the SINR is around twenty dBs, the throughput is equal to 3.00.

The steps S607 to S609 correspond to an evaluation of the system performance considering the uplink weighting vectors v_{nU} for the determined terminals 20.

At next step S610, the processor 300 checks whether or not the system evaluation function Ξ(n) for the group of data under process is upper than or equal to the evaluation function Ξ(n−1) determined for the previous processed group of data.

If Ξ(n)>Ξ(n−1), the processor 300 moves to step S611, otherwise the processor 300 moves to step S613. If Ξ(n)≧Ξ(n−1), nmax groups of data will be transferred simultaneously with nmax=n−1.

At step S611, the processor 300 checks if the variable n is equal to N. If n is different from N, the processor 300 moves to step S612, increments the variable n of one and returns to step S601. The processor 300 executes the loop made by the steps S601 to S612 as far as all the N groups of data have not been processed or if Ξ(n)≧Ξ(n−1).

If the variable n is equal to N, the processor 300 moves to step S613.

At step S613, the processor 300 determines, for each of the terminals 20 determined at step S606, the modulation and coding scheme to be used by the determined terminals 20 at step S606 for the uplink channel.

As example, if the SINR is comprised between zero and one dB, the modulation is QPSK modulation with a coding rate of ⅛. If the SINR is comprised between one and two dBs, the modulation is QPSK modulation with a coding rate of 1/7. If the SINR is comprised between two and three dBs, the modulation is QPSK modulation with a coding rate of ⅙. If the SINR is around twenty dBs, the modulation is 16 QAM with a coding rate of ¾.

At step S614, the processor 300 transfers the ordered list of the determined terminals at step S606, the corresponding uplink weighting vectors v_{nU} determined at step S607 for each of the terminals 20 comprised in the ordered list to an allocation module not shown in the FIG. 3. The allocation module inserts, as example within a timeslot of the downlink channel the ordered list of determined terminals 20 at step S606, the corresponding uplink weighting vectors v_{nU} and information related to the modulation and coding scheme determined at step S613 for each determined terminal 20.

Such information are then transferred through the downlink channel.

In a variant of realisation, instead of transferring the uplink weighting vectors v_{nU} determined at step S607 for each of the terminals 20 comprised in the ordered list to the allocation module, the processor 300 determines other downlink weighting vectors w′_{nD} of the base station 10 as follow: the processor 300 transfers information related to the determined uplink weighting vector v_{kU} to the terminal 20ₖ by weighting the transferred pilot signals to the terminal 20ₖ by downlink weighting vectors w′_{nD} of the base station 10 which enable each determined terminal 20, using the weighted pilot signals to determine the uplink weighting vector v_{kU}. Such weighted pilot signals are transferred as example in a predetermined downlink time slot.

FIG. 7 is an algorithm executed by the base station in order to determine the spatial multiplexing on the downlink channel according to a second mode of realisation of the present invention.

The present algorithm is executed each time the base station 10 has to transfer simultaneously at most N groups of data to at least one of the terminals 20₁ to 20_{K}.

The base station 10 transfers simultaneously, through its N antennas, the signals representatives of nmax groups of data, wherein nmax≦N. The base station 10 calculates K matrices, each matrix being representative of the achievable link conditions between a terminal 20k and the base station 10 and determines which terminal or terminals 20 has to receive at least a group of data according to the calculated matrices.

According to the second mode of realisation of the invention, the base station 10, determines for each of the nmax groups of data transferred simultaneously, a downlink weighting vector w_{nD} of the base station 10, the element of which multiply each duplicated signal to be transferred and a downlink weighting vector v_{nD} for each n-th group of data.

More precisely the present algorithm is executed by the processor 300 of the spatial multiplexer 100 of the base station 10.

At step S700, the processor 300 sets a variable noted n to 1. The variable n denotes the group of data under process.

At next step S701, the processor 300 calculates the matrix B̅ₙ according to the following formula: B̅ₙ=└Hₖ₍ₗ₎v_{lD,} . . . ,Hₖ₍ₙ₋₁₎v_{(n-1)D,}┘, where Hₖ₍ₗ₎ for l=1 to n−1 is the channel matrix between the terminal 20ₖ which have already been determined to send l-th group of data on the downlink channel and the base station 10 and v_{lD} is the terminal downlink weighting vector determined for the l-th group of data.

It has to be noted here that the base station 10 has knowledge of the channel matrix Hk₍ₗ₎ on the same manner as disclosed for Hₖ in the FIG. 5.

At next step S702, the processor 300 calculates a matrix Φₙ using the following formula: Φₙ=I− B̅ₙ( B̅ₙ^{H} B̅ₙ)⁻ B̅^{H}, where I is the identity matrix.

At next step S703, the processor 300 sets the variable k to one. The variable k denotes an indicia of the terminal 20ₖ under process.

At next step S704, the processor 300 calculates the matrix representative of the achievable link conditions between the terminal 20ₖ under process and the base station 10 using the following formula: H*ₖΦₙHₖ^{T}.

At next step S705, the processor 300 checks whether or not the variable k is equal to K.

If k is different from K, the processor 300 moves to step S706, increments k of one and returns to steps S704.

As far as k is different from K, the processor 300 executes the loop made by the steps S704 to S706.

If k is equal to K, the processor 300 moves to step S707.

The steps S701 to S706 correspond to the determination of K matrices, each matrix being representative of the achievable link conditions between the base station 10 and a terminal 20ₖ.

At step S707, the processor 300 determines the terminal 20 to which the n-th group of data under process has to be sent as the one which has the largest achievable signal to noise plus interference power ratio.

More precisely, the processor 300 determines, for the n-th group of data, the terminal noted \hat{k} which H*ₖΦₙHₖ^{T} satisfies the following formula:

$$\hat{k} = {arg}_{k} max \frac{{P}_{s}}{{P}_{kz}} {f}_{k} ρ 〈 {H}_{k}^{*} {Φ}_{n} {H}_{k}^{T} 〉 ,$$

where ρ<.> is the largest eigenvalue of the matrix <.>, argₖ max represents the terminal noted \hat{k} which has the largest value of

$$\frac{{P}_{s}}{{P}_{kz}} ρ 〈 {H}_{k}^{*} {Φ}_{n} {H}_{k}^{T} 〉$$

and fₖ is a priority coefficient.

Pₛ is the power of the signal transferred by the base station 10 through its antennas BSAnt1 to BSAntN and P_{kz} is the noise power matrix for the terminal 20ₖ.

It has to be noted here that, if fₖ is equal to one, the radio resources are rarely allocated to a terminal 20 which has a large noise power.

In a variant of realization, fₖ denotes a priority coefficient allocated to the terminal 20ₖ.

fₖ is preferably equal to:

$${f}_{k} = \frac{1}{( {P}_{s} / {P}_{kz} ) {M}_{k}^{α}}$$

where 0≦a≦1.

Using such priority coefficient fₖ, the present algorithm is efficient when some terminals 20 have a reduced number of antennas in comparison with other terminals 20. Even if terminals 20 have the same Pₛ/P_{kz}, a terminal 20 which has more antennas has on average larger eigenvalue ρ<H*ₖΦₙHₖ^{T}> thanks to the terminal's signal weighting. Using the power a, a priority can be given according to the number of antennas a terminal 20 has. A priority can then be given to a terminal 20 which has a reduced number of Mₖ antennas.

At next step S708, the processor 300 calculates the downlink weighting vector v_{nD} to be used by the determined terminal 20 for the n-th group of data using the following formula:

v_{nD}=e<H*ₖΦₙHₖ^{T}>, where k is the indicia of the determined terminal 20 at step S707, e<H*ₖΦₙHₖ^{T}> denotes the eigenvector corresponding to largest the eigenvalue of the matrix H*ₖΦₙHₖ^{T} of the terminal 20 determined at step S707.

Thanks to steps S706 and S707, the processor 300 determines the terminal \hat{k} which has to receive the n-th group of data and selects a downlink weighting vector v_{nD} for the determined terminal 20 and for the group of data n under process which maximizes the SINR of the terminal \hat{k}.

At next step S709, the processor 300 determines the achievable SINR of the determined terminal 20 using the following formula:

$${γ}_{n} = \frac{{P}_{s}}{{P}_{k ( n ) z}} {v}_{n} {H}_{k} {Φ}_{n} {H}_{k} {v}_{n D} .$$

Hₖ is the channel matrix of the determined terminal 20ₖ at step S707.

At next step S710, the processor 300 determines a system evaluation function Ξ(n) for the group of data under process.

As example, the system evaluation function Ξ(n) is expressed by the throughput and is equal to

$${\sum }_{l = 1}^{n} T ( {γ}_{l} )$$

where T(γₗ) represents the throughput of a group of data as a function of the SFNR γₗ. T(γₗ) is similar as the one disclosed at step S609, it will not be described anymore.

The steps S708 to S710 correspond to an evaluation of the system performance considering the uplink weighting vectors v_{nD} for the determined terminals 20.

At next step S711, the processor 300 checks whether or not the system evaluation function Ξ(n) for the group of data under process is upper than or equal to the evaluation function Ξ(n−1) determined for the previous processed group of data.

If Ξ(n)>Ξ(n−1), the processor 300 moves to step S712, otherwise the processor 300 moves to step S714. If Ξ(n)≧Ξ(n−1), nmax group of data will be transferred simultaneously with nmax=n−1.

At step S712, the processor 300 checks if the variable n is equal to N. If n is different from N, the processor 300 moves to step S713, increments the variable n of one and returns to step S701. The processor 300 executes the loop made by the steps S701 to S713 as far as all the N groups of data have not been processed or if Ξ(n)≧Ξ(n−1).

If the variable n is equal to N, the processor 300 moves to step S714.

At step S714, the processor 300 determines, for each of the terminals 20 determined at step S707 the modulation and coding scheme to be used by the determined terminals 20 for the downlink channel. Such determination is as example, as the one disclosed at step S613 of the FIG. 6.

At step S715 the processor 300 determines the base station downlink weighting vectors w_{nD} which have to be used for the respective the nmax groups of data to be transferred simultaneously as follow:
\sqrt{Pₛ}[w_{lD}, . . . ,w_{n max D}]=P′{(BB^{H})⁻¹B}*,
where P′=diag└\sqrt{Pₛ^{′(1)}}, \sqrt{Pₛ^{′(2)}}, . . . , \sqrt{Pₛ^{′(n max)}}┘,
B=[bₗ, . . . ,b_{n max}],
bₗ=Hₖ₍ₗ₎^{T}v_{lD} for l=1 to nmax with ∥v_{lD}∥=1.

Hₖ₍ₗ₎ is the channel matrix between the terminal 20ₖ and the base station 10 which have been determined to receive the l-th group of data on the downlink channel and v_{lD} is the terminal downlink weighting vector determined for the l-th group of data.

It has to be noted here that, setting n=nmax and using the relation B^{T}[w_{lD}, . . . , w_{nD}]=P′/Pₛ, we have:
v_{nD}(Hₖ₍ₙ₎w_{lD})=(Hₖ₍ₙ₎^{T}v_{nD})^{T}w_{lD}=bₙ^{T}w_{lD}=\sqrt{Pₛ^{′(n)}/Pₛ} for l=n and 0 otherwise.

This means that the determined terminal 20 does not receive any interference from other transferred groups of data at the same time. Based on the downlink weighting vectors v_{nD}, the terminal 20ₖ has a signal to noise ratio which is equal to

$${γ}_{k ← n} = \frac{{v}_{n D}^{T} {H}_{k ( n )} {w}_{n}}{{P}_{kz} {‖ {v}_{n D} ‖}^{2}} = \frac{{P}_{s}^{′ ( n )}}{{P}_{kz}}$$

Such formula shows that at step S707, the determined terminal 20ₖ is the one which has the largest achievable signal to noise plus interference power ratio among the terminals 20.
From \sqrt{Pₛ}[w_{lD}, . . . ,w_{nD}]=P!{(BB^{H})⁻¹B}* and ∥w_{nD}∥=1,
Pₛ=Pₛw_{nD}^{H}w_{nD}=Pₛ^{′(n)}dₙ^{H}(B^{H}B)⁻¹dₙ
dₙ=[0,0, . . . ,1]^{T}.

Therefore, Pₛ=Pₛ^{′(n)}dₙ^{H}(B^{H}B)⁻¹dₙ

At next step S716, the processor 300 transfers the elements of the downlink weighting vectors w₁ to wₙₘₐₓ of the base station 10 determined at step S715 to the multiplication modules noted Mulₗ₁ to Mul_{NN}, transfers the ordered list of the determined terminals 20 at step S707 to an allocation module not shown in the FIG. 3. The allocation module selects, for each of the determined terminal 20, a group of data which has a destination address equals to the determined terminal 20.

The groups of data are then transferred by the base station 10.

It has to be noted here that, the information related to the modulation and the coding scheme to be used by determined terminals 20 for the downlink channel are also transferred in a time slot of the downlink channel.

Each of the determined terminal 20 receives pilot signals and determines the downlink weighting vector based on the minimum-mean-square-error weight.

Each terminal 20 checks in the received group of data the destination terminal identifier and if the identified corresponds to its one, the terminal 20 identifies the modulation and coding scheme used for the downlink channel and reads the data.

Naturally, many modifications can be made to the embodiments of the invention described above without departing from the scope of the present invention.

1. Method for controlling the transfer of signals representatives of a group of data in a wireless telecommunication network comprising a first telecommunication device linked through plural second telecommunication devices through the wireless network, the first telecommunication device comprising at least two antennas, at least one of the second telecommunication devices comprising at least two antennas, characterised in that the method comprises the steps executed by the first telecommunication device of:
calculating at least two information, each information being representative of the achievable link conditions between the first telecommunication device and one second telecommunication device,
determining which second telecommunication device, among the at least two second telecommunication devices, is involved in the transfer of the group of data through the link according to the determined information,
determining at least a weighting vector to be used for the transfer of the group of data, the elements of the weighting vector weighting the signals representatives of the group of data transferred through at least two antennas.

2. Method according to claim 1, characterized in that the determination of the second device involved in the transfer of the group of data through the link is made also according to the number of antennas of each second telecommunication device.

3. Method according to claim 1 or 2, characterised in that each information representative of the achievable link conditions between the first telecommunication device and one second telecommunication device is a matrix representative of the achievable link conditions between the first telecommunication device and the second telecommunication device.

4. Method according to any of the claims 1 to 3, characterised in that the method comprises further step of determining the modulation and coding scheme to be used by the second telecommunication device involved in the transfer of the group of data.

5. Method according to claim 4, characterised in that the determination of the modulation and coding scheme to be used by the second telecommunication device involved in the transfer of the group of data is made using the determined weighting vector.

6. Method according to any of the claims 1 to 5, characterised in that the determined second telecommunication device is the second telecommunication device which is expected to receive signals representatives of the group of data transferred by the first telecommunication device.

7. Method according to any of the claims 1 to 5, characterised in that the at least one weighting vector to be used for the transfer of the group of data, is a weighting vector which weights the signals representatives of the group of data transferred by the first telecommunication device.

8. Method according to claim 7, characterised in that the first telecommunication device comprises N antennas, at most N groups of data are transferred simultaneously through the N antennas, and in that it is determined successively, for each group of data of the at most N groups of data, the second telecommunication device involved in the transfer of the group of data and the weighting vector to be used for the transfer of the group of data.

9. Method according to claim 8, characterised in that the second telecommunication device involved in the transfer of a group of data is determined by:
calculating a matrix Uₙ using the following formula:
$${U}_{n} = ( I - {\sum }_{l = 1}^{n - 1} {w}_{l D} {w}_{l D}^{H} ) ,$$
wherein I is the identity matrix, n is the identifier of the group of data for which the control of the transfer of the signals representatives of the group of data is currently done, l=1 to n−1 are the identifiers of the groups of data for which the control of the transfer of the signals representatives of the group of data is already done, w_{lD} is the weighting vector which weights the signals transferred by the first telecommunication device determined for the l-th group of data, ( )^{H} is the complex conjugate transpose of ( ),
calculating, for each second telecommunication device k, with k=1 to K, K being the number of second telecommunication devices, a matrix Rₖₙ which is the correlation matrix of interference and noise components for the second telecommunication device k,
$${R}_{kn} = {\sum }_{l = 1}^{n - 1} {P}_{s}^{( l )} {H}_{k} {w}_{l D} {w}_{l D}^{H} {H}_{k}^{H} + {P}_{kz} I ,$$
where Pₛ^{(l)} is the power of the signal transferred by the first telecommunication device through its N antennas for the l-th group of data, Hₖ is the channel matrix between the second telecommunication device k and the first telecommunication device, Pₖₛ is the noise power matrix for the second telecommunication devices,
calculating, for each second telecommunication device k, a matrix ψₖₙ=Uₙ^{H}Hₖ^{H}Rₖₙ⁻¹HₖUₙ which is representative of the achievable link conditions between the first telecommunication device and the second telecommunication device k,
determining among the K second telecommunication devices, the second telecommunication device \hat{k} as one involved in the transfer of the group of data which satisfies the following formula:
\hat{k}=argₖ max fₖ(ρ<ψₖₙ>), where ρ<.> is the largest eigenvalue of the matrix <.>, argₖ max represents the second telecommunication device k which has the largest value of fₖ(<ψₖₙ>), fₖ( ) is a priority function.

10. Method according to claim 9, characterized in that the priority function fₖ( ) is the identity function or a function which weights the largest eigenvalue of the matrix ψₖₙ by an averaged Signal to Noise Ratio over a long period of time or a wide frequency band or by the number of antennas of the second telecommunication device.

11. Method according to claim 9 or 10, characterised in that the weighting vector which weights the signals representatives of the group of data is determined for each group of data according to the following formula:
w_{nD}=e<ψₖₙ>, where e<ψₖₙ> is the eigenvector corresponding to the largest eigenvalue of the matrix ψₖₙ of the second telecommunication device involved in the transfer of the n-th group of data.

12. Method according to any of the claims 8 to 11, characterised in that the method comprises further step of determining, for each determined second telecommunication device which is expected to receive signals representatives of the group of data, an achievable signal to noise plus interference power ratio from the determined weighting vector which weights the signals representatives of the group of data transferred to the second telecommunication device.

13. Method according to any of the claims 1 to 5, characterised in that the determined second telecommunication device is the second telecommunication device which is expected to transfer signals representatives of the group of data to the first telecommunication device.

14. Method according to claim 13, characterised in that the at least one weighting vector to be used for the transfer of the group of data, is a weighting vector which weights the signals representatives of the group of data transferred by the second telecommunication device.

15. Method according to claim 14, characterised in that the first telecommunication device comprises N antennas, at most N groups of data are received simultaneously through the N antennas, and in that it is determined successively, for each group of data of the at most N groups of data, the second telecommunication device involved in the transfer of the group of data and the weighting vector to be used for the transfer of the group of data.

16. Method according to claim 15, characterised in that the second telecommunication device involved in the transfer of a group of data is determined by:
calculating the correlation matrix Rₙ of interference and noise components which is given by:
$${R}_{n} = {\sum }_{l = 1}^{n - 1} {P}_{s}^{( l )} {H}_{k ( l )}^{T} {v}_{l U} {v}_{l U}^{H} {H}_{k ( l )}^{*} + {R}_{I N} ,$$
where n is the identifier of the group of data for which the control of the transfer of the signals representatives of the group of data is currently done, l=1 to n−1 are the identifiers of the groups of data for which the control of the transfer of the signals representatives of the groups of data is already done, v_{lU} is the weighting vector which weights the signals representatives of the group of data transferred by the second telecommunication device k determined for the l-th group of data, with k=1 to K, K is the number of second telecommunication devices, ( )^{T} is the transpose of ( ), ( )^{H} is the complex conjugate transpose of ( ), Hₖ is the channel matrix between the second telecommunication device k and the first telecommunication device, Hk₍ₗ₎ is the channel matrix between the second telecommunication device k which has already been determined to send the l-th group of data and the first telecommunication device, ( )* is the complex conjugate of ( ), R_{IN}=E└z_{IN}(p)z_{IN}^{H}(p)┘, z_{IN}(p)=[z₁(p), . . . , z_{Mk}(p)] is the interference plus noise components of the first telecommunication device and p is the p-th received sample, Pₛ^{(l)} is the power of the signal transferred by the second telecommunication device through its N antennas for the l-th group of data,
calculating, for each second telecommunication device k, a matrix H*ₖRₙ⁻¹Hₖ^{T} which is representative of the achievable link conditions between the first telecommunication device and the second telecommunication device k,
determining among the K second telecommunication devices, the second telecommunication device \hat{k} as the one involved in the transfer of the group of data which satisfies the following formula:
\hat{k}=argₖ max fₖ(ρ<H*ₖRₙ⁻¹Hₖ^{T}>), where p<.> is the largest eigenvalue of the matrix <.>, argₖ max represents the second telecommunication device k which has the largest value of fₖ(ρ<H*ₖRₙ⁻¹Hₖ^{T}>), fₖ( ) is a priority function.

17. Method according to claim 16, characterized in that the priority function fₖ( ) is the identity function or a function which weights the largest eigenvalue of the matrix H*ₖRₙ⁻¹Hₖ^{T} by an averaged Signal to Noise Ratio over a long period of time or a wide frequency band or by the number of antennas of the second telecommunication device.

18. Method according to claim 16 or 17, characterised in that the weighting vector which weights the signals representatives of the group of data is determined for each group of data according to the following formula:
v_{nU}=e<H*ₖRₙ⁻¹Hₖ^{T}>, where e<H*ₖRₙ⁻¹Hₖ^{T}> is the eigenvector corresponding to largest eigenvalue of the matrix H*ₖRₙ⁻¹Hₖ^{T} of the second telecommunication device involved in the transfer of the n-th group of data.

19. Method according to any of the claims 16 to 18, characterised in that the method comprises further step of determining, for each determined second telecommunication device, an achievable signal to noise plus interference power ratio from the determined weighting vector which weights the signals representatives of the group of data transferred to the second telecommunication device.

20. Method according to claim 19, characterised in that the method comprises further step of evaluating, for each determined second telecommunication device, of the system performance considering the determined weighting vector for the determined second telecommunication device.

21. Method according to claim 1 to 6, characterised in that two weighting vectors are determined, a weighting vector w_{nD} which weights the signals representatives of the group of data transferred by the first telecommunication device and a weighting vector v_{nD} which weights the signals representatives of the group of data received by the second telecommunication device.

22. Method according to claim 21, characterised in that the first telecommunication device comprises N antennas, at most N groups of data are received simultaneously through the N antennas, and in that it is determined successively, for each group of data of the at most N groups of data, the second telecommunication device involved in the transfer of the group of data and the weighting vector to be used for the transfer of the group of data.

23. Method according to claim 22, characterised in that the second telecommunication device involved in the transfer of a group of data is determined by:
calculating a matrix B̅ₙ=└Hₖ₍ₗ₎v_{lD,}, . . . ,Hₖ₍ₙ₋₁₎v_{(n-1)D,}┘, n is the identifier of the group of data for which the control of the transfer of the signals representatives of the group of data is currently done, l=1 to n−1 are the identifiers of the groups of data for which the control of the transfer of the signals representatives of the group of data is already done where Hₖ₍ₗ₎ is the channel matrix of the second telecommunication k which is expected to receive signals representatives of the l-th group of data transferred by the first telecommunication device, v_{lD} is the weighting vector which weights the signals representatives of the group of data determined for the l-th group of data,
calculating a matrix Φₙ=I− B̅ₙ( B̅ₙ^{H} B̅ₙ)⁻¹ B̅^{H}, where I is the identity matrix,
calculating, for each second telecommunication device k, k=1 to K, K is the number of second telecommunication devices, a matrix H*ₖΦₙHₖ^{T} which is representative of the achievable link conditions between the first telecommunication device and the second telecommunication device k,
determining among the K second telecommunication devices, the second telecommunication device k̅ as the one involved in the transfer of the group of data which satisfies the following formula:
$$\hat{k} = {arg}_{k} max \frac{{P}_{s}}{{P}_{kz}} {f}_{k} ρ 〈 {H}_{k}^{*} {Φ}_{n} {H}_{k}^{T} 〉 ,$$
where ρ<.> is the largest eigenvalue of the matrix <.>, argₖ max represents the second telecommunication device k which has the largest value of
$$\frac{{P}_{s}}{{P}_{kz}} ρ 〈 {H}_{k}^{*} {Φ}_{n} {H}_{k}^{T} 〉 ,$$
fₖ is a priority coefficient, Pₛ is the power of the signals transferred by the first telecommunication device and P_{kz} is the noise power matrix for the second telecommunication devices.

24. Method according to claim 23, characterised in that the weighting vector v_{nD} which weights the signals representatives of the group of data transferred by the second telecommunication device is calculating using the following formula: v_{nD}=e<H*ₖΦₙHₖ^{T}>, where e<H*ₖΦₙHₖ^{T}) is the eigenvector corresponding to the largest eigenvalue of the matrix H*ₖΦₙHₖ^{T} of the second telecommunication device involved in the transfer of the n-th group of data.

25. Method according to any of the claims 22 to 24, characterised in that the method comprises further step of evaluating, for each determined second telecommunication device, of the system performance considering the determined weighting vector for the determined second telecommunication device.

26. Method according to claim 21, characterised in that each weighting vector w_{nD} which weights the signals transferred by the first telecommunication device to the determined second telecommunication device for the n-th group of data is calculating using the following formula: \sqrt{Pₛ}[w_{lD}, . . . ,w_{n max D}]=P′{(BB^{H})⁻¹B*},
where P′=diag└\sqrt{Pₛ^{′(1)}}, \sqrt{Pₛ^{′(s)}}, . . . , \sqrt{Pₛ^{′(n max)}}┘,
B=[bₗ, . . . , b_{n max}],
bₗ=Hₖ₍ₗ₎^{T}v_{lD} for l=1 to nmax with ∥v_{lD}∥=1 and nmax is the number of group of data transferred simultaneously.

27. Device for controlling the transfer of signals representatives of a group of data in a wireless telecommunication network comprising a first telecommunication device linked through plural second telecommunication devices through the wireless network, the first telecommunication device comprising at least two antennas, at least one of the second telecommunication devices comprising at least two antennas, characterised in that the device is include in the first telecommunication device and comprises:
means for calculating at least two information, each information being representative of the achievable link conditions between the first telecommunication device and one second telecommunication device,
means for determining which second telecommunication device among the at least two second telecommunication devices is involved in the transfer of the group of data through the link according to the determined information,
means for determining at least a weighting vector to be used for the transfer of the group of data, the elements of the weighting vector weighting the signals representatives of the group of data transferred through at least two antennas.

28. Computer program which can be directly loadable into a programmable device, comprising instructions or portions of code for implementing the steps of the method according to claims 1 to 26, when said computer program is executed on a programmable device.
